(19) United States
(12) Patent Application Publication
(10) Pub. No.: US 2025/0201882 A1
(43) Pub. Date: Jun. 19, 2025

(54) APPARATUS FOR RECOVERING DEGRADATION OF ANODE CATALYST AND METHOD THEREOF

(71) Applicants: Hyundai Motor Company, Seoul (KR); Kia Corporation, Seoul (KR)

(72) Inventor: Ga Jeon Chon, Seoul (KR)

(73) Assignees: Hyundai Motor Company, Seoul (KR); Kia Corporation, Seoul (KR)

(21) Appl. No.: 18/752,648

(22) Filed: Jun. 24, 2024

(30) Foreign Application Priority Data
Dec. 19, 2023 (KR) 10-2023-0186228

(51) Int. Cl. H01M 8/04858; H01M 8/04223; H01M 8/0444; H01M 8/04537; H01M 8/04746; H01M 8/10

(52) U.S. Cl. CPC H01M 8/0488; H01M 8/04231; H01M 8/04447; H01M 8/04559; H01M 8/04753; H01M 2008/1095

(57) ABSTRACT

In an apparatus and method for recovering degradation of an anode catalyst, the apparatus increases a hydrogen flow rate supplied to the anode of the operating fuel cell stack above a normal value, estimates a nitrogen concentration of the anode based on the hydrogen concentration of the anode, and pulse-controls an output voltage of the fuel cell stack in response that the nitrogen concentration of the anode reaches a preset value, electrochemically oxidizing carbon monoxide adsorbed on the surface of the anode catalyst.

### CROSS-REFERENCE TO RELATED APPLICATION

The present application claims priority to Korean Patent Application No. 10-2023-0186228, filed on Dec. 19, 2023, the entire contents of which is incorporated herein for all purposes by this reference.

### BACKGROUND OF THE PRESENT DISCLOSURE

### Field of the Present Disclosure

The present disclosure relates to a technology for recovering degradation of an anode catalyst by removing carbon monoxide adsorbed on a surface of the anode catalyst.

### Description of Related art

Generally, a polymer electrolyte membrane fuel cell (PEMFC) is used as a fuel cell for a vehicle. For the polymer electrolyte membrane fuel cell to normally exhibit high output performance of tens of kW or more under various driving conditions of a vehicle, the polymer electrolyte membrane fuel cell is required to operate stably in a wide current density range.

The reaction for generating electricity in the fuel cell occurs in a membrane-electrode assembly (MEA) having a perfluorinated sulfonic acid (PFSA) ionomer-based membrane and anode/cathode electrodes. After the hydrogen supplied to the anode, which is an oxidizing electrode, is separated into hydrogen ions (protons) and electrons, the hydrogen ions move through the membrane toward the cathode which is a reducing electrode, and the electrons move to the cathode through an external circuit. At the cathode, oxygen molecules, hydrogen ions, and electrons react together to generate electricity, and at the same time, water (H₂O) and heat are generated as reaction by-products.

Meanwhile, when driving a fuel cell vehicle, carbon monoxide (CO) generated by carbon corrosion is adsorbed on the surface of the anode catalyst in the fuel cell stack, so that the anode catalyst may lose its catalytic activity. That is, the anode catalyst may be poisoned by carbon monoxide and lose catalytic activity.

The poisoned anode catalyst may cause chemical degradation of the fuel cell stack and ultimately reduce the durability of the fuel cell. Accordingly, there is a need to provide a scheme of removing carbon monoxide adsorbed on the surface of the anode catalyst in the fuel cell stack.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing an apparatus and method for recovering degradation of an anode catalyst configured for electrochemically oxidizing carbon monoxide adsorbed on the surface of the anode catalyst by increasing a hydrogen flow rate supplied to the anode of the operating fuel cell stack above a reference value, estimating a nitrogen concentration of the anode based on the hydrogen concentration of the anode, and pulse-controlling an output voltage of the fuel cell stack in response that the nitrogen concentration of the anode reaches a preset value.

Another aspect of the present disclosure provides an apparatus and method for recovering degradation of an anode catalyst configured for electrochemically oxidizing carbon monoxide adsorbed on the surface of the anode catalyst by increasing a hydrogen flow rate supplied to the anode of the operating fuel cell stack above a reference value, estimating a nitrogen concentration of the anode based on the hydrogen concentration of the anode, and inducing a reverse voltage of the fuel cell stack in response that the nitrogen concentration of the anode reaches a preset value.

Yet another aspect of the present disclosure provides an apparatus and method for recovering degradation of an anode catalyst configured for electrochemically oxidizing carbon monoxide adsorbed on the surface of the anode catalyst by increasing the hydrogen flow rate supplied to the anode of the fuel cell stack above a reference value in response that the amount of decrease in the output voltage of the fuel cell stack is within a threshold range in a section where an output current of the fuel cell stack is constant, estimating a nitrogen concentration of the anode based on the hydrogen concentration of the anode, pulse-controlling the output voltage of the fuel cell stack in response that the nitrogen concentration of the anode reaches a preset value, increasing a hydrogen flow rate supplied to an anode of the operating fuel cell stack above a reference value in response that the amount of decrease in the output voltage of the fuel cell stack exceeds the threshold range, estimating a nitrogen concentration of the anode based on a hydrogen concentration of the anode, and inducing a reverse voltage of the fuel cell stack in response that the nitrogen concentration of the anode reaches a preset value.

The technical problems to be solved by the present disclosure are not limited to the aforementioned problems, and any other technical problems not mentioned herein will be clearly understood from the following description by those skilled in the art to which the present disclosure pertains. Also, it may be easily understood that the objects and advantages of the present disclosure may be realized by the units and combinations thereof recited in the claims.

According to an aspect of the present disclosure, an apparatus for recovering degradation of an anode catalyst includes a sensor configured for measuring a hydrogen concentration of an anode in a fuel cell stack in operation, and a controller that increases a hydrogen flow rate supplied to the anode above a reference value, estimates a nitrogen concentration of the anode based on the hydrogen concentration of the anode, and pulse-controls an output voltage of the fuel cell stack in response that the nitrogen concentration of the anode reaches a preset value.

According to an exemplary embodiment of the present disclosure, the controller may be configured for controlling an operation to be repeated a preset number of times, wherein the operation causes the fuel cell stack to output an upper limit voltage for a preset time and then output a lower limit voltage for a preset time.

According to an exemplary embodiment of the present disclosure, the controller may electrochemically oxidize carbon monoxide adsorbed on a surface of the anode catalyst through pulse-control of the output voltage of the fuel cell stack.

According to an exemplary embodiment of the present disclosure, the controller may monitor an amount of decrease in the output voltage of the fuel cell stack in a section where an output current of the fuel cell stack is constant, and pulse-control the output voltage of the fuel cell stack in response that the amount of decrease in the output voltage of the fuel cell stack is within a threshold range.

According to an exemplary embodiment of the present disclosure, the controller may be configured to determine a first value by subtracting the output voltage of the fuel cell stack before the pulse-control from the output voltage of the fuel cell stack after the pulse-control, determine a threshold based on the amount of decrease in the output voltage of the fuel cell stack, and terminate the pulse-control in response that the first value is greater than or equal to the threshold.

According to an exemplary embodiment of the present disclosure, the controller may induce a reverse voltage of the fuel cell stack in response that the amount of decrease in the output voltage of the fuel cell stack exceeds the threshold range and the nitrogen concentration of the anode reaches a preset value.

According to an exemplary embodiment of the present disclosure, the controller may induce the reverse voltage by controlling the fuel cell stack to rapidly output power in response that the nitrogen concentration of the anode reaches the preset value.

According to an exemplary embodiment of the present disclosure, the controller may restore the hydrogen flow rate supplied to the anode of the fuel cell stack to the reference value and open a fuel-line purge valve (FPV).

According to an exemplary embodiment of the present disclosure, the controller may electrochemically oxidize carbon monoxide adsorbed on a surface of the anode catalyst by use of the reverse voltage of the fuel cell stack.

According to another aspect of the present disclosure, a method of recovering degradation of an anode catalyst includes monitoring, by a controller, an amount of decrease in an output voltage of a fuel cell stack in a section where an output current of the fuel cell stack is constant, increasing, by the controller, a hydrogen flow rate supplied to an anode of the fuel cell stack above a reference value in response that the amount of decrease in the output voltage of the fuel cell stack is within a threshold range, estimating, by the controller, a nitrogen concentration of the anode based on a hydrogen concentration of the anode, and pulse-controlling, by the controller, the output voltage of the fuel cell stack in response that the nitrogen concentration of the anode reaches a preset value.

According to an exemplary embodiment of the present disclosure, the pulse-controlling of the output voltage of the fuel cell stack may include controlling an operation to be repeated a preset number of times, and wherein the operation causes the fuel cell stack to output an upper limit voltage for a preset time and then output a lower limit voltage for a preset time.

According to an exemplary embodiment of the present disclosure, the pulse-controlling of the output voltage of the fuel cell stack may include electrochemically oxidizing carbon monoxide adsorbed on a surface of the anode catalyst.

According to an exemplary embodiment of the present disclosure, the pulse-controlling of the output voltage of the fuel cell stack may further include determining a first value by subtracting the output voltage of the fuel cell stack before the pulse-control from the output voltage of the fuel cell stack after the pulse-control, determining a threshold based on the amount of decrease in the output voltage of the fuel cell stack, and terminating the pulse-control in response that the first value is greater than or equal to the threshold.

According to yet another aspect of the present disclosure, a method of recovering degradation of an anode catalyst includes monitoring, by a controller, an amount of decrease in an output voltage of a fuel cell stack in a section where an output current of the fuel cell stack is constant, increasing, by the controller, a hydrogen flow rate supplied to an anode of the fuel cell stack above a reference value in response that the amount of decrease in the output voltage of the fuel cell stack exceeds a threshold range, estimating, by the controller, a nitrogen concentration of the anode based on a hydrogen concentration of the anode, and inducing, by the controller, a reverse voltage of the fuel cell stack in response that the nitrogen concentration of the anode reaches a preset value.

According to an exemplary embodiment of the present disclosure, the inducing of the reverse voltage of the fuel cell stack may include controlling, by the controller, the fuel cell stack to rapidly output power.

According to an exemplary embodiment of the present disclosure, the inducing of the reverse voltage of the fuel cell stack may further include restoring, by the controller, the hydrogen flow rate supplied to the anode of the fuel cell stack to the reference value, and opening, by the controller, a fuel-line purge valve (FPV).

According to an exemplary embodiment of the present disclosure, the inducing of the reverse voltage of the fuel cell stack may further include electrochemically oxidizing, by the controller, carbon monoxide adsorbed on a surface of the anode catalyst by the reverse voltage of the fuel cell stack.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram illustrating a fuel cell system provided in a fuel cell vehicle to which an exemplary embodiment of the present disclosure is applied;

FIG. 2 is a block diagram illustrating a configuration of an apparatus for recovering degradation of an anode catalyst according to an exemplary embodiment of the present disclosure;

FIG. 3 is a diagram illustrating a process of inducing a reverse voltage of a fuel cell stack by a controller provided in an apparatus for recovering degradation of an anode catalyst according to an exemplary embodiment of the present disclosure;

FIG. 4 is a diagram illustrating the performance of an apparatus for recovering degradation of an anode catalyst according to an exemplary embodiment of the present disclosure;

FIG. 5 is a diagram illustrating another example of the performance of an apparatus for recovering degradation of an anode catalyst according to an exemplary embodiment of the present disclosure;

FIG. 6 is a flowchart illustrating a method of recovering degradation of an anode catalyst according to an exemplary embodiment of the present disclosure;

FIG. 7 is a flowchart illustrating a method of recovering degradation of an anode catalyst according to another exemplary embodiment of the present disclosure; and

FIG. 8 is a block diagram illustrating a determining system for executing a method of recovering degradation of an anode catalyst according to various exemplary embodiments of the present disclosure.

It may be understood that the appended drawings are not necessarily to scale, presenting a somewhat simplified representation of various features illustrative of the basic principles of the present disclosure. The predetermined design features of the present disclosure as included herein, including, for example, specific dimensions, orientations, locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, various exemplary embodiments of the present disclosure will be described in detail with reference to the exemplary drawings. In adding the reference numerals to the components of each drawing, it should be noted that the identical or equivalent component is designated by the identical numeral even when they are displayed on other drawings. Furthermore, in describing the exemplary embodiment of the present disclosure, a detailed description of the related known configuration or function will be omitted when it is determined that it interferes with the understanding of the exemplary embodiment of the present disclosure.

Furthermore, terms, such as first, second, A, B, (a), (b) or the like may be used herein when describing components of the present disclosure. The terms are provided only to distinguish the elements from other elements, and the essences, sequences, orders, and numbers of the elements are not limited by the terms. Furthermore, unless defined otherwise, all terms used herein, including technical or scientific terms, include the same meanings as those generally understood by those skilled in the art to which the present disclosure pertains. The terms defined in the generally used dictionaries should be construed as including the meanings that coincide with the meanings of the contexts of the related technologies, and should not be construed as ideal or excessively formal meanings unless clearly defined in the specification of the present disclosure.

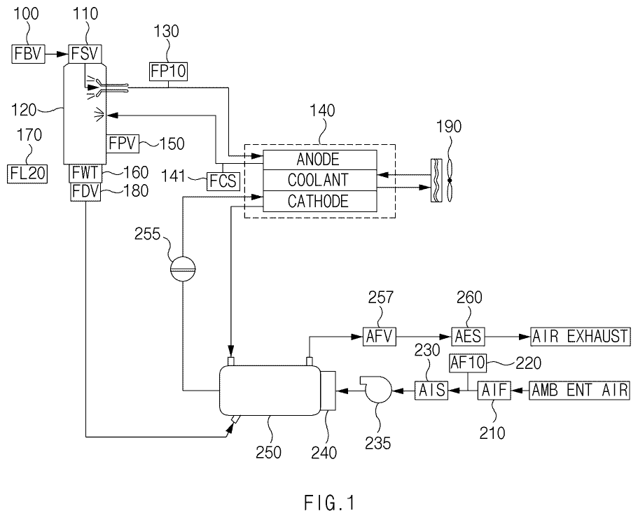

FIG. 1 is a diagram illustrating a fuel cell system provided in a fuel cell vehicle to which an exemplary embodiment of the present disclosure is applied.

As shown in FIG. 1, a fuel cell system provided in a fuel cell vehicle to which an exemplary embodiment of the present disclosure is applied may include a fuel block valve (FBV) 100, a fuel supply valve (FSV) 110, a fuel ejector (FEJ) 120, a fuel pressure sensor 10 (FP10) 130, a fuel cell stack 140, a fuel concentration sensor (FCS) 141, a fuel-line purge valve (FPV) 150, a fuel-line water trap (FWT) 160, a fuel-line level sensor (FL20) 170, a fuel-line drain valve (FDV) 180, a radiator fan 190, an air intake filter (AIF) 210, an air flow sensor (AF10) 220, an air intake silencer (AIS) 230, an air compressor 235, an air cooler 240, an air humidifier 250, an air cut-off valve (ACV) 255, an air exhaust valve (AEV) 257, and an air exhaust silencer (AES) 260.

In the instant case, the FBV 100 is configured to perform blocking hydrogen supplied to the fuel cell stack 140. The FSV 110 is configured to perform controlling the hydrogen pressure supplied to the fuel cell stack 140. The FEJ 120 is configured to perform applying a pressure to hydrogen to supply the hydrogen to the fuel cell stack 140. The FP10 130 is configured to perform measuring the hydrogen pressure supplied to the fuel cell stack 140. The FCS 141 is configured to perform measuring (or estimating) the hydrogen concentration of the anode of the fuel cell stack 140 (i.e., the hydrogen concentration of the anode channel). The FPV 150 is configured to perform discharging hydrogen electrode condensate and impurities within the fuel cell stack 140. The FWT 160 is configured to perform storing water. The FL20 170 is configured to perform measuring the level of water stored in the FWT 160. The FDV 180 is configured to perform discharging water stored in the FWT 160.

Furthermore, the AIF 210 is configured to perform filtering out foreign substances (dust or the like) contained in ambient air. The AF10 220 is a sensor configured for measuring which is configured for measuring an air flow rate. The AIS 230 eliminates intake noise. The air compressor 235 is configured to perform supplying external air (ambient air) to the air humidifier 250. The air cooler 240 is configured to perform cooling the air supplied to the air humidifier 250. The air humidifier 250 is configured to perform controlling the humidity of air. The ACV 255 is configured to perform blocking the air supplied to the cathode of the fuel cell stack 140. The AEV 257 is configured to perform discharging hydrogen from the cathode to the outside through an air exhaust line. The AES 260 eliminates noise generated when exhaust gas is discharged through the air exhaust line.

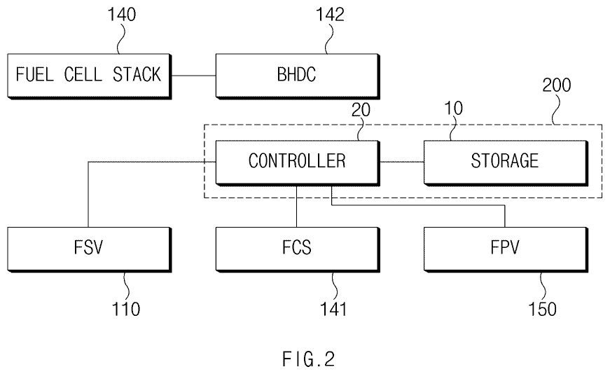

FIG. 2 is a block diagram illustrating a configuration of an apparatus for recovering degradation of an anode catalyst according to an exemplary embodiment of the present disclosure.

As shown in FIG. 2, an apparatus 200 for recovering degradation of an anode catalyst according to an exemplary embodiment of the present disclosure may include storage 10 and a controller 20. In the instant case, depending on a scheme of implementing the apparatus 200 for recovering degradation of an anode catalyst according to an exemplary embodiment of the present disclosure, components may be combined with each other to be implemented as one, or some components may be omitted.

Regarding each component, first, the storage 10 may store various logic, algorithms, and programs required in the processes of increasing a hydrogen flow rate supplied to the anode of the operating fuel cell stack 140 above a normal value (or reference value), estimating a nitrogen concentration of the anode based on the hydrogen concentration of the anode, and pulse-controlling an output voltage of the fuel cell stack 140 when the nitrogen concentration of the anode reaches a preset value. For reference, nitrogen is configured to restore the anode catalyst poisoned by carbon monoxide, so that the higher the nitrogen concentration in the anode, the better, but realistically, it may not be increased indefinitely. In the instant case, the preset value of the anode nitrogen concentration means the optimal nitrogen concentration which may be realistically achieved (e.g., 50%).

The storage 10 may store various logic, algorithms, and programs required in the processes of increasing a hydrogen flow rate supplied to the anode of the operating fuel cell stack 140 above a normal value, estimating a nitrogen concentration of the anode based on the hydrogen concentration of the anode, and inducing a reverse voltage of the fuel cell stack 140 when the nitrogen concentration of the anode reaches a preset value.

The storage 10 may store various logic, algorithms, and programs required in the processes of increasing the hydrogen flow rate supplied to the anode of the fuel cell stack 140 above a normal value when the amount of decrease in the output voltage of the fuel cell stack 140 is within a threshold range in a section where an output current of the fuel cell stack 140 is constant, estimating a nitrogen concentration of the anode based on the hydrogen concentration of the anode, pulse-controlling the output voltage of the fuel cell stack 140 when the nitrogen concentration of the anode reaches a preset value, increasing a hydrogen flow rate supplied to an anode of the operating fuel cell stack 140 above a normal value when the amount of decrease in the output voltage of the fuel cell stack 140 exceeds the threshold range, estimating a nitrogen concentration of the anode based on a hydrogen concentration of the anode, and inducing a reverse voltage of the fuel cell stack 140 when the nitrogen concentration of the anode reaches a preset value.

The storage 10 may store various logic, algorithms, and programs required in a process of controlling a bidirectional high-voltage DC-DC converter (BHDC) 142 to repeat an operation of causing the fuel cell stack 140 to output an upper limit voltage for a preset time and then output a lower limit voltage for a preset time a preset number of times as a process of pulse-controlling the output voltage of the fuel cell stack 140.

The storage 10 may store various logic, algorithms, and programs required in a process of terminating pulse-control when the value obtained by subtracting the output voltage of the fuel cell stack 140 before the pulse-control from the output voltage of the fuel cell stack 140 after the pulse-control increases compared to the amount of decrease in the output voltage of the fuel cell stack 140, and controlling the BHDC 142 to repeat pulse-control a preset number of times when the value does not increase as a process of determining the end portion of pulse-control for the output voltage of the fuel cell stack 140. In the instant case, the amount of decrease in the output voltage of the fuel cell stack 140 is a value obtained in a process of determining whether to perform initial pulse-control.

The storage 10 may store various logic, algorithms, and programs required in the processes of restoring the hydrogen flow rate supplied to the anode of the fuel cell stack 140 to a normal value when the nitrogen concentration of the anode reaches a preset value, opening the FPV 150, and controlling the BHDC 142 to enable the fuel cell stack 140 to rapidly output power as a process of inducing a reverse voltage of the fuel cell stack 140.

The controller 20 may perform overall control so that each component is configured to perform its function. The controller 20 may be implemented in a form of hardware or software, or may be implemented in a combination of hardware and software. The controller 20 may be implemented as a microprocessor, but is not limited thereto.

As various exemplary embodiments of the present disclosure, the controller 20 may increase a hydrogen flow rate supplied to the anode of the operating fuel cell stack 140 above a normal value (or reference value) (e.g., twice the normal value), estimate a nitrogen concentration of the anode (i.e., a hydrogen concentration in the anode channel) based on the hydrogen concentration of the anode (i.e., the nitrogen concentration in the anode channel), and pulse-control an output voltage of the fuel cell stack 140 when the nitrogen concentration of the anode reaches a preset value (e.g., 50%) so that degradation of the anode catalyst may be recovered by electrochemically oxidizing carbon monoxide adsorbed on the surface of the anode catalyst. In the instant case, the anode channel refers to the outlet end portion of the channel through which hydrogen is supplied to the anode.

Because the technology for estimating the nitrogen concentration based on the hydrogen concentration is well-known in the art, the controller 20 may use any one of various estimation schemes. Furthermore, the normal value, which is the hydrogen flow rate supplied to the fuel cell stack 140 which is operating normally, is a preset value.

The controller 20 may be configured for controlling the BHDC 142 to repeat the process (taking a total of 1 minute) of allowing the fuel cell stack 140 to output an upper limit voltage for a preset time (e.g., 30 seconds) and then output the lower limit voltage for a preset time (e.g., 30 seconds) a preset number of times (e.g., 5×n, where n is a natural number) as a process of pulse-controlling an output voltage of the fuel cell stack 140. In the instant case, the controller 20 may be implemented to perform the function of the BHDC 142 instead.

As various exemplary embodiments of the present disclosure, the controller 20 may increase a hydrogen flow rate supplied to the anode of the operating fuel cell stack 140 above a normal value (or reference value) (e.g., twice the normal value), estimate the nitrogen concentration of the anode based on the hydrogen concentration of the anode, and induce the reverse voltage of the fuel cell stack 140 when the nitrogen concentration of the anode reaches a preset value so that degradation of the anode catalyst may be recovered by electrochemically oxidizing carbon monoxide adsorbed on the surface of the anode catalyst.

As a process of inducing the reverse voltage of the fuel cell stack 140, the controller 20 may restore the hydrogen flow rate supplied to the anode of the fuel cell stack 140 to a normal value when the nitrogen concentration reaches a preset value, open the FPV 150, and control the BHDC 142 to enable the fuel cell stack 140 to rapidly output power. In the instant case, the controller 20 may restore the hydrogen flow rate supplied to the anode of the fuel cell stack 140 to the normal value by use of the FSV 110. Furthermore, the controller 20 is configured to control the BHDC 142 to restore the hydrogen flow rate supplied to the anode of the fuel cell stack 140 to the normal value and immediately cause the fuel cell stack 140 to rapidly output power. Furthermore, the controller 20 may be configured for controlling the BHDC 142 to rapidly output a voltage corresponding to the hydrogen flow rate supplied to the anode of the fuel cell stack 140. Furthermore, the controller 20 may increase the hydrogen flow rate supplied to the anode of the operating fuel cell stack 140 to more than twice the normal value.

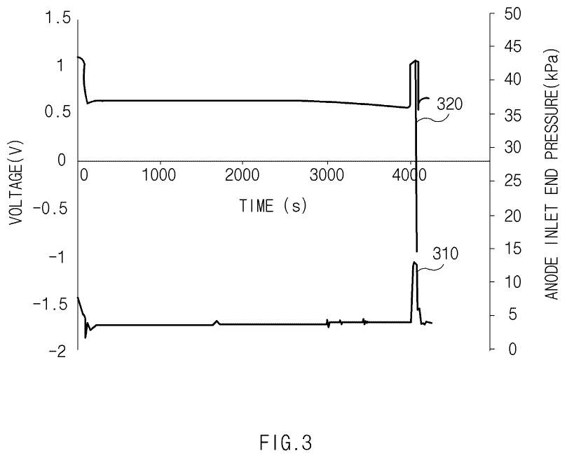

FIG. 3 is a diagram illustrating a process of inducing a reverse voltage of a fuel cell stack by a controller provided in an apparatus for recovering degradation of an anode catalyst according to an exemplary embodiment of the present disclosure.

Referring to FIG. 3, reference numeral 310 represents a pressure graph at an inlet end portion of the anode, and reference numeral 320 represents a voltage graph of the fuel cell stack 140.

First, the controller 20 increases the hydrogen flow rate supplied to the anode of the fuel cell stack 140 to twice the normal value. Accordingly, the pressure 310 at the inlet end portion of the anode increases rapidly.

Thereafter, when the controller 20 applies a sudden output to a load, the hydrogen flow rate is rapidly consumed and the pressure 310 at the inlet end portion of the anode decreases. In the instant case, the controller 20 may immediately restore the hydrogen flow rate supplied to the anode of the fuel cell stack 140 to the normal value. Furthermore, the fuel cell stack 140 may output a current corresponding to the hydrogen flow rate.

When a sudden output is applied to a load in such a manner, the pressure at the inlet end portion of the anode changes suddenly and a reverse voltage is generated momentarily (e.g., 5 msec). In the instant case, the range of the reverse voltage may be −0.4V to −1V, for example.

As various exemplary embodiments of the present disclosure, the controller 20 may integrate the various exemplary embodiments of the present disclosure. That is, the controller 20 may monitor the amount of decrease (ΔV) in the output voltage of the fuel cell stack 140 in a section where the output current of the fuel cell stack 140 is constant. In the instant case, the controller 20 may obtain the output voltage of the fuel cell stack 140 through the BHDC 142 or obtain the output voltage of the fuel cell stack 140 through a voltage sensor located at the output terminal of the fuel cell stack 140. Furthermore, the controller 20 may obtain the output current of the fuel cell stack 140 through a current sensor located at the output terminal of the fuel cell stack 140.

Thereafter, the controller may increase the hydrogen flow rate supplied to the anode of the fuel cell stack 140 above a normal value when the amount of decrease in the output voltage of the fuel cell stack 140 is within a threshold range (e.g., 10 mV<ΔV≤100 mV), estimate a nitrogen concentration of the anode based on the hydrogen concentration of the anode, and pulse-control the output voltage of the fuel cell stack 140 when the nitrogen concentration of the anode reaches a preset value.

In the instant case, the controller 20 may further determine whether the following Equation 1 is met as a condition for performing the pulse-control. That is, the controller 20 may initiate the pulse-control when the current voltage reduction slope over time is smaller than the past time-dependent voltage reduction slope and the amount in decrease in the output voltage of the fuel cell stack 140 is within a threshold range.

$$\frac{{ΔV}_{n + 1}}{{ΔV}_{t + 1}} < \frac{{ΔV}_{n}}{Δ {t}_{n}} \qquad [ Equation 1 ]$$

### Where

$$\frac{{ΔV}_{n + 1}}{{ΔV}_{t + 1}}$$

represents the voltage (V) reduction slope at the current (n+1) time (t), and

$$\frac{{ΔV}_{n}}{Δ {V}_{t}}$$

represents the voltage reduction slope at the past (n) time.

Furthermore, to pulse-control the output voltage of the fuel cell stack 140, the controller 20 may be configured for controlling the BHDC 142 to repeat the process of causing the fuel cell stack 140 to output an upper limit voltage for a preset time (e.g., 30 seconds) and then output a lower limit voltage for a preset time (e.g., 30 seconds) (total of 1 minute) a preset number of times.

Furthermore, the controller 20 may terminate pulse-control when the value (ΔV_{recovery}) obtained by subtracting the output voltage of the fuel cell stack 140 before the pulse-control from the output voltage of the fuel cell stack 140 after the pulse-control increases by more than a preset value compared to the amount (ΔV) of decrease in the output voltage of the fuel cell stack 140. In the instant case, the controller 20 may be configured to determine the termination of the pulse-control when the following Equation 2 is satisfied.

$${Δ V}_{recovery} \geq 0.2 \times Δ V \qquad [ Equation 2 ]$$

Where ΔV_{recovery} represents the value obtained by subtracting the output voltage of the fuel cell stack 140 before pulse-control from the output voltage of the fuel cell stack 140 after pulse-control, and ΔV represents the amount of decrease in the output voltage of the fuel cell stack 140 obtained in a process of determining whether to perform initial pulse-control.

The controller 20 may restore the hydrogen flow rate supplied to the anode of the fuel cell stack 140 to a normal value and restore the open condition of the FPV 150. In the instant case, in a process of increasing the nitrogen concentration of the anode and pulse-controlling the output voltage of the fuel cell stack 140, the controller 20 may stop the hydrogen electrode purge or reduce the frequency.

To the contrary, when the amount (ΔV) of decrease in the output voltage of the fuel cell stack 140 exceeds the threshold range (e.g., 10 mV<ΔV≤100 mV) (i.e., exceeds 100 mV), the controller 20 may increase the hydrogen flow rate supplied to the anode of the operating fuel cell stack 140 above a normal value, estimate the nitrogen concentration of the anode based on the hydrogen concentration of the anode, and induce the reverse voltage of the fuel cell stack 140 when the nitrogen concentration of the anode reaches a preset value.

In the instant case, to induce the reverse voltage of the fuel cell stack 140, the controller 20 may restore the hydrogen flow rate supplied to the anode of the fuel cell stack 140 to a normal value, open the FPV 150, and control the BHDC 142 to enable the fuel cell stack 140 to rapidly output power. Furthermore, the controller 20 may be configured for controlling the BHDC 142 to restore the hydrogen flow rate supplied to the anode of the fuel cell stack 140 to the normal value and immediately cause the fuel cell stack 140 to rapidly output power.

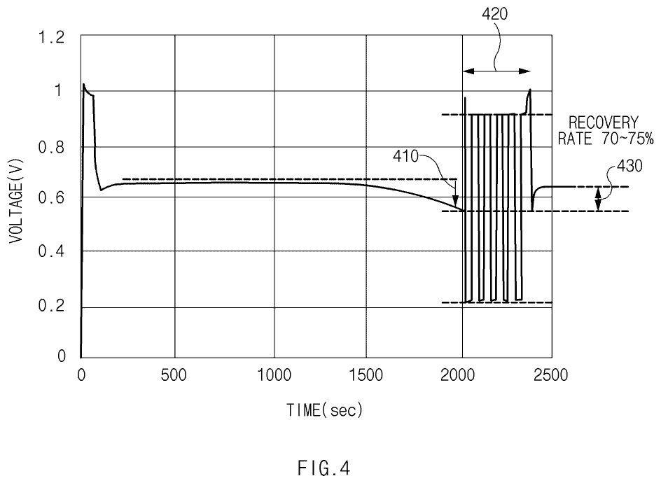

FIG. 4 is a diagram illustrating the performance of an apparatus for recovering degradation of an anode catalyst according to an exemplary embodiment of the present disclosure, and illustrates the degree of recovery from degradation of an anode catalyst through pulse-control.

In FIG. 4, the perpendicular axis represents voltage (V), the horizontal axis represents time (sec), reference numeral 410 represents the decrease (ΔV) in output voltage of the fuel cell stack 140, reference numeral 420 represents a section in which the output voltage of the fuel cell stack 140 is pulse-controlled, and reference numeral 430 represents the recovery amount of the output voltage of the fuel cell stack 140.

As shown in FIG. 4, in a process 420 of pulse-controlling the output voltage of the fuel cell stack 140, as a result of repeating the process of maintaining the output voltage of the fuel cell stack 140 at 0.2 V for 30 seconds and then maintaining the output voltage of the fuel cell stack 140 at 0.9 V for 30 seconds (taking 1 minute) for a total of 5 minutes, the recovery rate of the output voltage of the fuel cell stack 140 is 70 to 75%.

To the contrary, when pulse-control for the output voltage of the fuel cell stack 140 is not performed and when the output voltage of the fuel cell stack 140 is maintained at 0.2V for a total of 5 minutes, the recovery rate of the output voltage of the fuel cell stack 140 is 14 to 51%.

Accordingly, it may be understood that pulse-control of the output voltage of the fuel cell stack 140 exerts significant influence on recovery of the output voltage of the fuel cell stack 140.

The relationship between the reduction amount (ΔV) of the output voltage of the fuel cell stack 140 and the voltage recovery rate is as follows: the voltage recovery rate is 20 to 30% when the voltage decrease amount is −10 mV, the voltage recovery rate is 50% when the voltage decrease amount is −50 mV, the voltage recovery rate is 70 to 75% when the voltage decrease amount is −100 mV, and the voltage recovery rate is 65 to 73% when the voltage decrease amount is −200 mV. Accordingly, as the voltage decrease amount increases, the voltage recovery rate increases, but when the voltage decrease amount is greater than −100 mV, the voltage recovery rate converges to the voltage recovery rate corresponding to −100 mV.

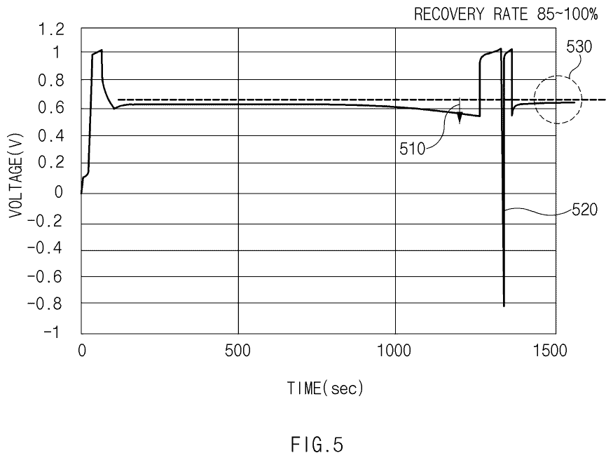

FIG. 5 is a diagram illustrating another example of the performance of an apparatus for recovering degradation of an anode catalyst according to an exemplary embodiment of the present disclosure, and illustrates the degree of recovery from degradation of an anode catalyst by a reverse voltage.

As shown in FIG. 5, the vertical axis represents voltage (V), the horizontal axis represents time (sec), and it may be confirmed that the voltage recovery rate is 85 to 100% by a reverse voltage 520 of −0.4 V or less when a voltage decrease 510 of −100 mV occurs.

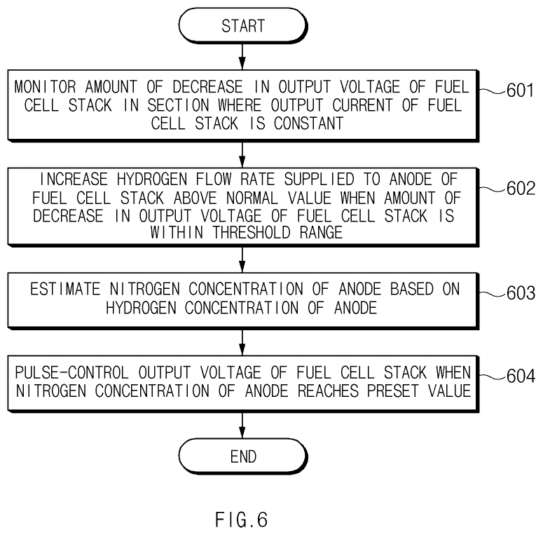

FIG. 6 is a flowchart illustrating a method of recovering degradation of an anode catalyst according to an exemplary embodiment of the present disclosure.

First, in 601, the controller 20 monitors the amount of decrease in the output voltage of the fuel cell stack 140 in a section where the output current of the fuel cell stack 140 is constant.

Accordingly, when the amount of decrease in the output voltage of the fuel cell stack 140 is within a threshold range, in 602, the controller 20 increases the hydrogen flow rate supplied to the anode of the fuel cell stack 140 above a normal value.

Accordingly, in 603, the controller 20 estimates the nitrogen concentration of the anode based on the hydrogen concentration of the anode.

Accordingly, when the nitrogen concentration of the anode reaches a preset value, in 604, the controller 20 pulse-controls the output voltage of the fuel cell stack 140.

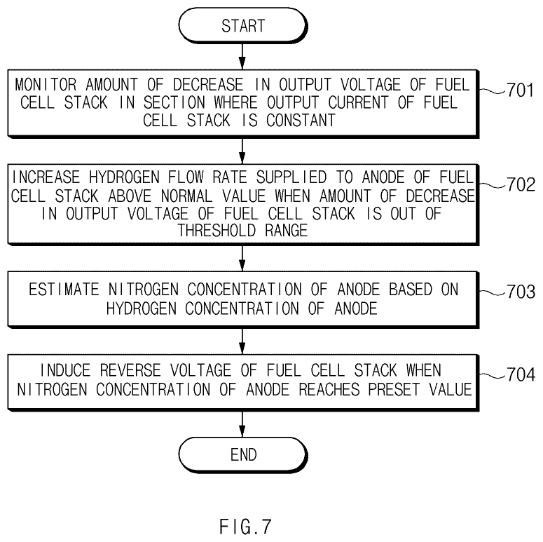

FIG. 7 is a flowchart illustrating a method of recovering degradation of an anode catalyst according to another exemplary embodiment of the present disclosure.

First, in 701, the controller 20 monitors the amount of decrease in the output voltage of the fuel cell stack 140 in a section where the output current of the fuel cell stack 140 is constant.

Accordingly, when the amount of decrease in the output voltage of the fuel cell stack 140 exceeds a threshold range, in 702, the controller 20 increases the hydrogen flow rate supplied to the anode of the fuel cell stack 140 above a normal value.

Accordingly, in 703, the controller 20 estimates the nitrogen concentration of the anode based on the hydrogen concentration of the anode.

Accordingly, when the nitrogen concentration of the anode reaches a preset value, in 704, the controller 20 induces a reverse voltage of the fuel cell stack 140.

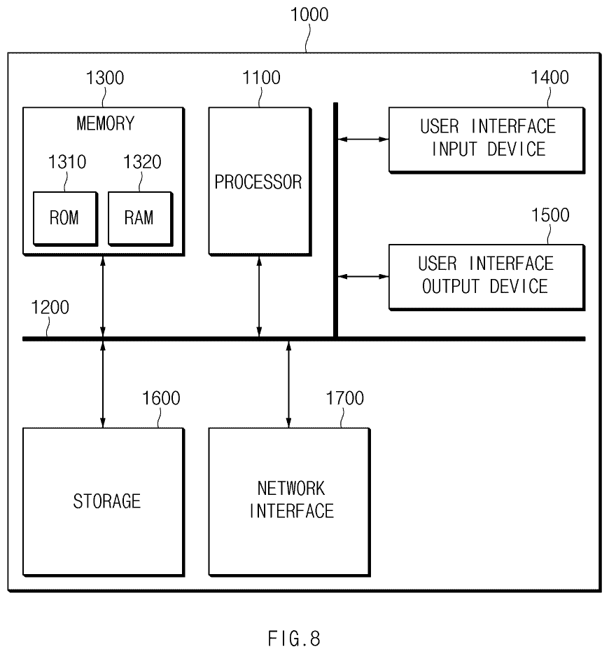

FIG. 8 is a block diagram illustrating a determining system for executing a method of recovering degradation of an anode catalyst according to various exemplary embodiments of the present disclosure.

Referring to FIG. 8, a method of recovering degradation of an anode catalyst according to an exemplary embodiment of the present disclosure described above may be implemented through a computing system 1000. The computing system 1000 may include at least one processor 1100, a memory 1300, a user interface input device 1400, a user interface output device 1500, storage 1600, and a network interface 1700 connected through a system bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random Access Memory (RAM) 1320.

Accordingly, the processes of the method or algorithm described in relation to the exemplary embodiments of the present disclosure may be implemented directly by hardware executed by the processor 1100, a software module, or a combination thereof. The software module may reside in a storage medium (that is, the memory 1300 and/or the storage 1600), such as a RAM, a flash memory, a ROM, an EPROM, an EEPROM, a register, a hard disk, solid state drive (SSD), a detachable disk, or a CD-ROM. The exemplary storage medium is coupled to the processor 1100, and the processor 1100 may read information from the storage medium and may write information in the storage medium. In another method, the storage medium may be integrated with the processor 1100. The processor 1100 and the storage medium may reside in an application specific integrated circuit (ASIC). The ASIC may reside in a user terminal. In another method, the processor 1100 and the storage medium may reside in the user terminal as an individual component.

The control device may be at least one microprocessor operated by a predetermined program which may include a series of commands for carrying out the method included in the aforementioned various exemplary embodiments of the present disclosure.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Furthermore, the terms such as “unit”, “module”, etc. included in the specification mean units for processing at least one function or operation, which may be implemented by hardware, software, or a combination thereof.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for recovering degradation of an anode catalyst, the apparatus comprising:
a sensor configured for measuring a hydrogen concentration of an anode in a fuel cell stack; and
a controller operatively connected to the sensor and configured to:
increase a hydrogen flow rate supplied to the anode above a reference value,
estimate a nitrogen concentration of the anode based on the hydrogen concentration of the anode, and
pulse-control an output voltage of the fuel cell stack in response that the nitrogen concentration of the anode reaches a preset value.

2. The apparatus of claim 1, wherein the controller is further configured to control an operation to be repeated a preset number of times, and wherein the operation causes the fuel cell stack to output an upper limit voltage for a preset time and then output a lower limit voltage for a preset time.

3. The apparatus of claim 1, wherein the controller is further configured to electrochemically oxidize carbon monoxide adsorbed on a surface of the anode catalyst through pulse-control of the output voltage of the fuel cell stack.

4. The apparatus of claim 1, wherein the controller is further configured to:
monitor an amount of decrease in the output voltage of the fuel cell stack in a section where an output current of the fuel cell stack is constant, and
pulse-control the output voltage of the fuel cell stack in response that the amount of decrease in the output voltage of the fuel cell stack is within a threshold range.

5. The apparatus of claim 4, wherein the controller is further configured to:
determine a value by subtracting the output voltage of the fuel cell stack before the pulse-control from the output voltage of the fuel cell stack after the pulse-control,
determine a threshold based on the amount of decrease in the output voltage of the fuel cell stack, and
terminate the pulse-control in response that the value is greater than or equal to the threshold.

6. The apparatus of claim 4, wherein the controller is further configured to induce a reverse voltage of the fuel cell stack in response that the amount of decrease in the output voltage of the fuel cell stack exceeds the threshold range and the nitrogen concentration of the anode reaches the preset value.

7. The apparatus of claim 6, wherein the controller is further configured to induce the reverse voltage by controlling the fuel cell stack to output power in response that the nitrogen concentration of the anode reaches the preset value.

8. The apparatus of claim 7, wherein the controller is further configured to restore the hydrogen flow rate supplied to the anode of the fuel cell stack to the reference value and open a fuel-line purge valve (FPV).

9. The apparatus of claim 6, wherein the controller is further configured to electrochemically oxidize carbon monoxide adsorbed on a surface of the anode catalyst by use of the reverse voltage of the fuel cell stack.

10. A method of recovering degradation of an anode catalyst, the method comprising:
monitoring, by a controller, an amount of decrease in an output voltage of a fuel cell stack in a section where an output current of the fuel cell stack is constant;
increasing, by the controller, a hydrogen flow rate supplied to an anode of the fuel cell stack above a reference value in response that the amount of decrease in the output voltage of the fuel cell stack is within a threshold range;
estimating, by the controller, a nitrogen concentration of the anode based on a hydrogen concentration of the anode; and
pulse-controlling, by the controller, the output voltage of the fuel cell stack in response that the nitrogen concentration of the anode reaches a preset value.

11. The method of claim 10, wherein the pulse-controlling of the output voltage of the fuel cell stack includes controlling an operation to be repeated a preset number of times, and wherein the operation causes the fuel cell stack to output an upper limit voltage for a preset time and then output a lower limit voltage for a preset time.

12. The method of claim 10, wherein the pulse-controlling of the output voltage of the fuel cell stack includes electrochemically oxidizing carbon monoxide adsorbed on a surface of the anode catalyst.

13. The method of claim 10, wherein the pulse-controlling of the output voltage of the fuel cell stack includes:
determining a value by subtracting the output voltage of the fuel cell stack before the pulse-control from the output voltage of the fuel cell stack after the pulse-control;
determining a threshold based on the amount of decrease in the output voltage of the fuel cell stack; and
terminating the pulse-control in response that the value is greater than or equal to the threshold.

14. A method of recovering degradation of an anode catalyst, the method comprising:
monitoring, by a controller, an amount of decrease in an output voltage of a fuel cell stack in a section where an output current of the fuel cell stack is constant;
increasing, by the controller, a hydrogen flow rate supplied to an anode of the fuel cell stack above a reference value in response that the amount of decrease in the output voltage of the fuel cell stack exceeds a threshold range;
estimating, by the controller, a nitrogen concentration of the anode based on a hydrogen concentration of the anode; and
inducing, by the controller, a reverse voltage of the fuel cell stack in response that the nitrogen concentration of the anode reaches a preset value.

15. The method of claim 14, wherein the inducing of the reverse voltage of the fuel cell stack includes controlling, by the controller, the fuel cell stack to output power.

16. The method of claim 15, wherein the inducing of the reverse voltage of the fuel cell stack further includes:
restoring, by the controller, the hydrogen flow rate supplied to the anode of the fuel cell stack to the reference value; and
opening, by the controller, a fuel-line purge valve (FPV).

17. The method of claim 14, wherein the inducing of the reverse voltage of the fuel cell stack includes electrochemically oxidizing, by the controller, carbon monoxide adsorbed on a surface of the anode catalyst by the reverse voltage of the fuel cell stack.

18. The method of claim 14, wherein the inducing of the reverse voltage of the fuel cell stack includes: inducing the reverse voltage of the fuel cell stack in response that the amount of decrease in the output voltage of the fuel cell stack exceeds the threshold range and the nitrogen concentration of the anode reaches the preset value.

19. The method of claim 14, wherein the inducing of the reverse voltage of the fuel cell stack includes: inducing the reverse voltage by controlling the fuel cell stack to output power in response that the nitrogen concentration of the anode reaches the preset value.
